(19) United States
(12) Patent Application Publication
(10) Pub. No.: US 2013/0077950 A1
(43) Pub. Date: Mar. 28, 2013

(54) APERTURE CONTROLING MECHANISM FOR IMAGE RECORDING DEVICE

(71) Applicants: KAO-CHI LIU, TAIPEI CITY (TW); CHI-WU LO, HSINCHU COUNTY (TW); YAO-CHIN YANG, TAICHUNG CITY (TW); CHAO-HSI WANG, HSINCHU COUNTY (TW)

(72) Inventors: KAO-CHI LIU, TAIPEI CITY (TW); CHI-WU LO, HSINCHU COUNTY (TW); YAO-CHIN YANG, TAICHUNG CITY (TW); CHAO-HSI WANG, HSINCHU COUNTY (TW)

(73) Assignee: VI-TAI TECHNOLOGY CO., LTD., NEW TAIPEI CITY (TW)

(21) Appl. No.: 13/244,154

(22) Filed: Sep. 23, 2011

(51) Int. Cl. G03B 9/16; G03B 9/18

(52) U.S. Cl. 396/497

(57) ABSTRACT

An image recording device includes a base plate; a blade assembly; and a driving mechanism. The base plate is formed with a guiding slot and a first axle. The blade assembly includes a first blade and a second blade stacked on the base plate and hinged to the first axle. The first blade is formed with a first pivot slot thereon, which has two first inner walls formed apart oppositely. The second blade is formed with a second pivot slot thereon, which has two second inner walls formed apart oppositely. The distance between the two second inner walls is greater than the distance between the two first inner walls. The driving mechanism includes a pin member projected through the guiding slot, the first pivot slot, and the second pivot slot. The first and second blades are driven by the pin member. Thereby, the image recording device can be miniaturized.

### BACKGROUND OF THE INVENTION

1. Field of the Invention

The instant disclosure relates to an image recording device; more particularly, to an image recording device having an improved blade assembly.

2. Description of Related Art

Conventional cameras and digital cameras of nowadays use aperture blades and shutter blades for exposure control. Specifically, the aperture blades control the amount of light that enters the camera during a period of time, and the shutter blades control the length of time that the light hits the recording surface. The aperture and shutter blades are important features for the lens unit while recording a photo.

However, the miniaturization of the digital cameras has put significant restraint in designing the camera base. For example, as shown in FIG. 1, for smaller cameras, a base plate la must be sized down accordingly. In this manner, a blade 2a (aperture or shutter) would become oversized relative to the base plate la. Therefore, the ability not to undermine the blade 2a operation while miniaturizing the camera itself is one of the main concerns today.

### SUMMARY OF THE INVENTION

The instant disclosure provides an image recording device, which includes a blade assembly. At least one blade of the blade assembly can lag behind other blade to form the desired blade pattern, and the blades are arranged in a stacked manner to save space. Thereby, a base plate of the image recording device can be reduced in size for miniaturizing the image recording device.

The image recording device of the instant disclosure comprises: a base plate; a blade assembly; and a driving mechanism. The base plate has an aperture, a guiding slot, and a first axle formed thereon. The blade assembly has a first blade and a second blade disposed in a stacked manner and hinged to the first axle. The first blade has a first pivot slot formed thereon, and the first pivot slot is defined by two opposing first inner walls. Similarly, the second blade has a second pivot slot formed thereon, and the second pivot slot is defined by two opposing second inner walls. The distance between the second inner walls is greater than the distance between the first inner walls. The driving mechanism includes a pin member, which is movably projected through the guiding slot, the first pivot slot, and the second pivot slot. The first and second blades are driven by the pin member.

For the instant disclosure, the first and second blades are hinged to the first axle, and the second inner walls are spaced further apart versus the first inner walls. Such design allows the stacked blades to rotate differently. The above configuration enables the image recording device to be miniaturized.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is an internal view of a conventional camera.

FIG. 2 is an exploded view for an image recording device of a first embodiment of the instant disclosure.

FIG. 3 shows the image recording device for the first embodiment of the instant disclosure at an open position.

FIG. 4 shows the image recording device for the first embodiment of the instant disclosure being operated from an open position to a closed position.

FIG. 5 shows the image recording device for the first embodiment of the instant disclosure at the closed position.

FIG. 6 shows the image recording device for the first embodiment of the instant disclosure being operated from the closed position to the open position.

FIG. 7 is an exploded view for an image recording device of a second embodiment of the instant disclosure.

FIG. 8 shows the image recording device for the second embodiment of the instant disclosure at an open position.

FIG. 9 shows the image recording device for the second embodiment of the instant disclosure being operated from an open position to a closed position.

FIG. 10 shows the image recording device for the second embodiment of the instant disclosure at the closed position.

FIG. 11 shows the image recording device for the second embodiment of the instant disclosure being operated from the closed position to the open position.

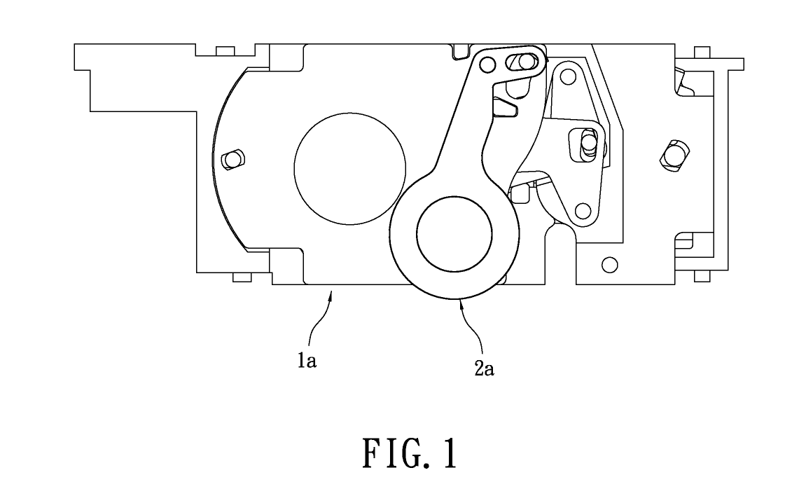

### DETAILED DESCRIPTION OF PREFERRED EMBODIMENTS

### First Embodiment

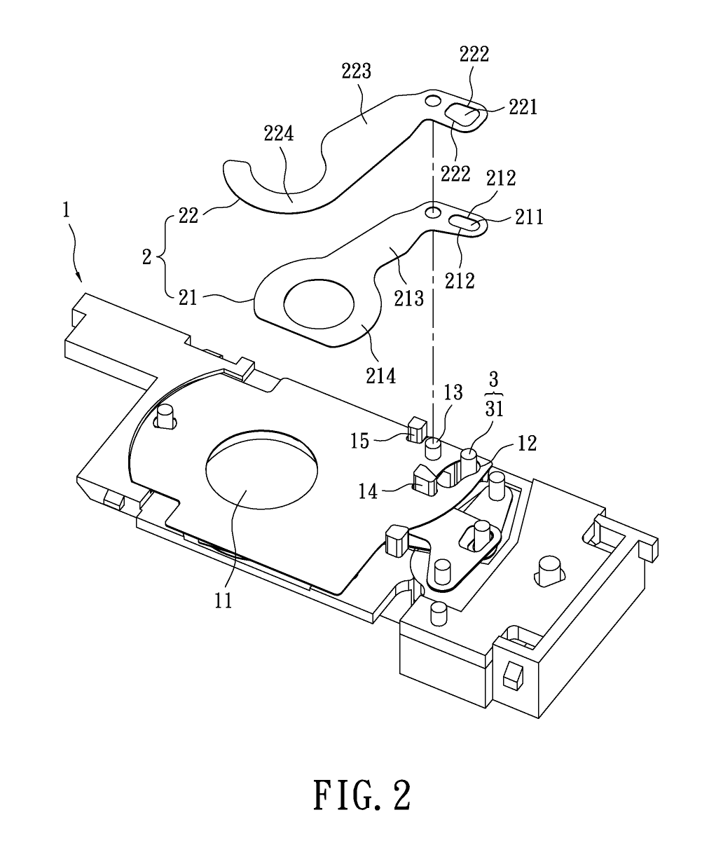

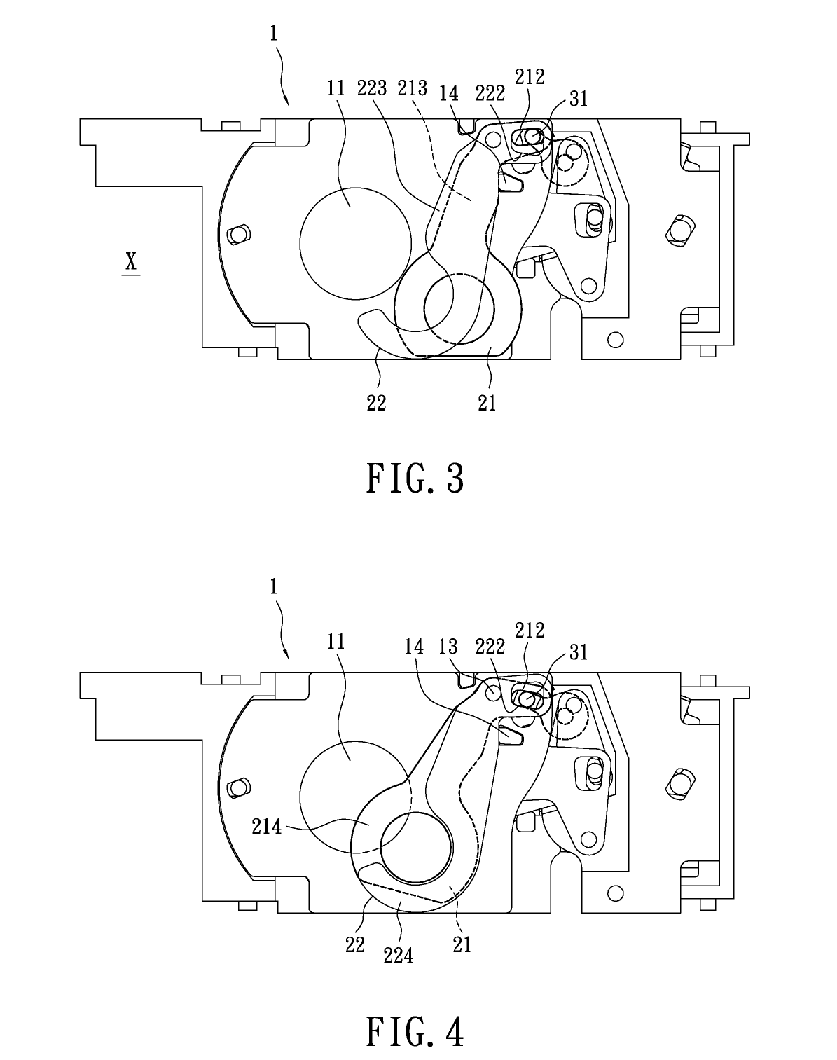

Please refer to FIGS. 2˜7, which show a first embodiment of the instant disclosure. Specifically, FIG. 2 shows an exploded view of the instant embodiment, while FIGS. 3˜6 show various operation states of the instant embodiment.

An image recording device is shown in FIG. 2, which comprises a base plate 1, a blade assembly 2, and a driving mechanism 3. The blade assembly 2 and the driving mechanism 3 are both arranged on the base plate 1. In particular, the blade assembly 2 is driven by the driving mechanism 3. For the instant embodiment, the blade assembly 2 includes a set of aperture blades, but is not restricted thereto.

An aperture 11 and a guiding slot 12 are formed on the base plate 1. In addition, a first axle 13, a first retaining block 14, and a second retaining block 15 are formed protrudingly on the base plate 1, and all preceding elements protrude in the same direction.

The blades assembly 2 includes a first blade 21 and a second blade 22. The blades are arranged in a stacked manner on the base plate 1 and hinged to the first axle 13.

The first blade 21 has an arm portion 213, which is extended in forming a covering portion 214. The arm portion 213 further has a first pivot slot 211 formed thereon. The first pivot slot 211 has a first inner gauge defined by the two opposing inner walls 212. The arm portion 213 is hinged to the first axle 13.

Similarly, the second blade 22 also has an arm portion 223, which is extended likewise in forming a covering portion 224. The arm portion 223 further has a second pivot slot 221 formed thereon. The second pivot slot 221 has a second inner gauge defined by two opposing inner walls 222. Notably, the distance between the two second inner walls 222 is greater than the distance between the two first inner walls 212. The arm portion 223 is hinged to the first axle 13.

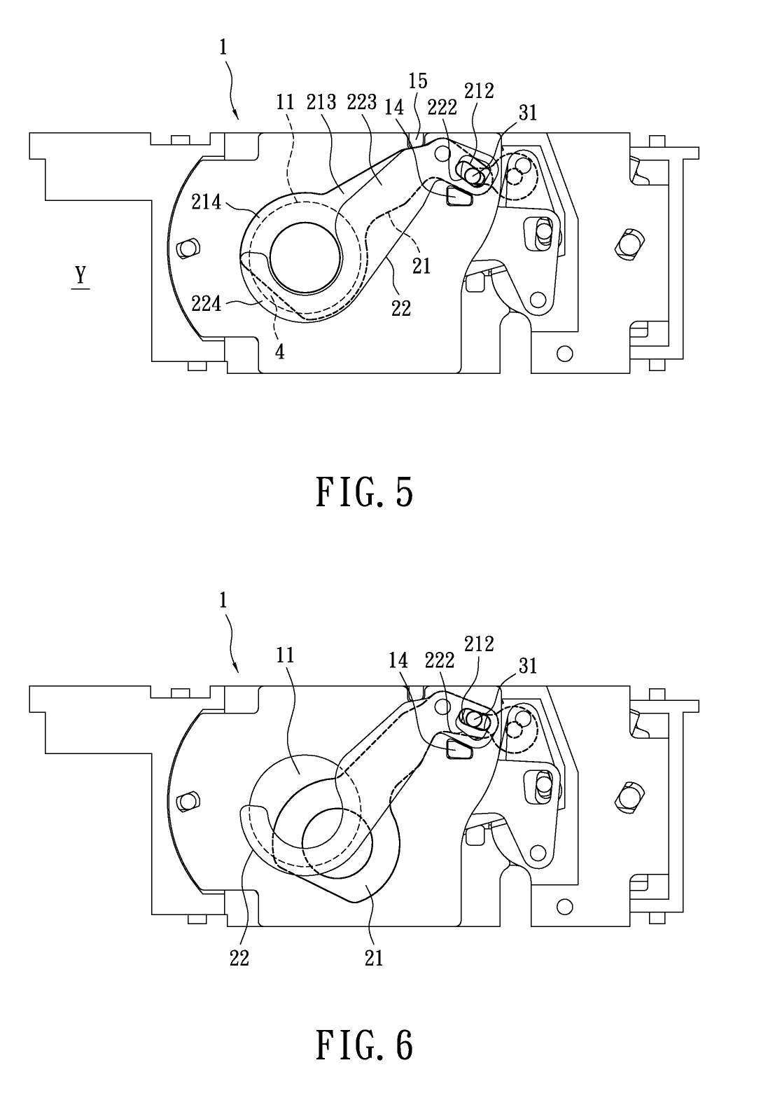

The driving mechanism 3 includes a pin member 31, which is movably projected through the guiding slot 12, the first pivot slot 211, and the second pivot slot 221. By moving against the first inner walls 212 and the second inner walls 222, the pin member 31 can switch the blade assembly 2 between an open position X and a closed position Y over the aperture 11 (as shown in FIGS. 3 and 5).

Different operation states of the image recording device are illustrated in FIGS. 3˜6. The blade assembly 2 shown in the figures is a set of aperture blades. Detailed descriptions of each operation state are given herein.

Please refer to FIG. 3 in conjunction with FIG. 2. In FIG. 3, the blade assembly 2 is oriented at the open position X. Specifically, the first blade 21 and the second blade 22 are held away from the aperture 11. Meanwhile, the arm portion 213 of the first blade 21 and the arm portion 223 of the second blade 22 abut to the first retaining block 14. The pin member 31 is being hugged by the first inner walls 212 and abutted to one of the second inner wall 222.

Notably, the first blade 21 and the second blade 22 are arranged in an overlapping manner, which reduces the required occupying area over the base plate 1. Such configuration allows the image recording device to be miniaturized.

Please refer to FIG. 4 in conjunction with FIG. 2. FIG. 4 shows the transitioning of the blade assembly 2 from the open position X to the closed position Y. As mentioned previously, the distance between the two second inner walls 222 is greater than the distance between the two first inner walls 212. Therefore, relative to FIG. 3, when the pin member 31 starts to move, the first blade 21 is set in motion rotatably first by the pin member 31. The pin member 31 also moves toward the opposite second inner wall 222. By pushing the opposite second inner wall 222, the pin member 31 forces the second blade 22 to rotate as well, before stopping at the closed position Y.

Although the first blade 21 and the second blade 22 are both hinged to the axle 13, the rotation of the second blade 22 lags behind the first blade 21. In other words, the turning angle of the second blade 22 is comparatively smaller than the first blade 21. Thereby, when the first and second blades 21 and 22 are rotated, the covering portions 214 and 224 can form the desired pattern over the aperture 11.

Please refer to FIG. 5 in conjunction with FIG. 2. In FIG. 5, the blade assembly 2 is oriented at the closed position Y. The first and second blades 21 and 22 are both arranged over the aperture 11. The arm portions 213 and 223 of the first and second blade 21 and 22 are abutted to the second retaining block 15. Especially, a small opening 4 is formed between the covering portion 214 of the first blade 21 and the aperture 11, while the covering portion 224 of the second blade 22 covers the opening 4.

Please refer to FIG. 6 in conjunction with FIG. 2. FIG. 6 shows the returning of the blade assembly 2 from the closed position Y to the open position X. Like before, the pin member 31 first forces the first blade 21 to rotate, and after a predetermined delay, the second blade 22 is forced to follow the first blade 21, before stopping at the open position X.

For explaining purposes, the blade assembly 2 of the instant embodiment includes two blades. However, when in use, the number of the blades is not restricted. For example, the blade assembly 2 may have at least three blades arranged in an overlapping manner.

### Second Embodiment

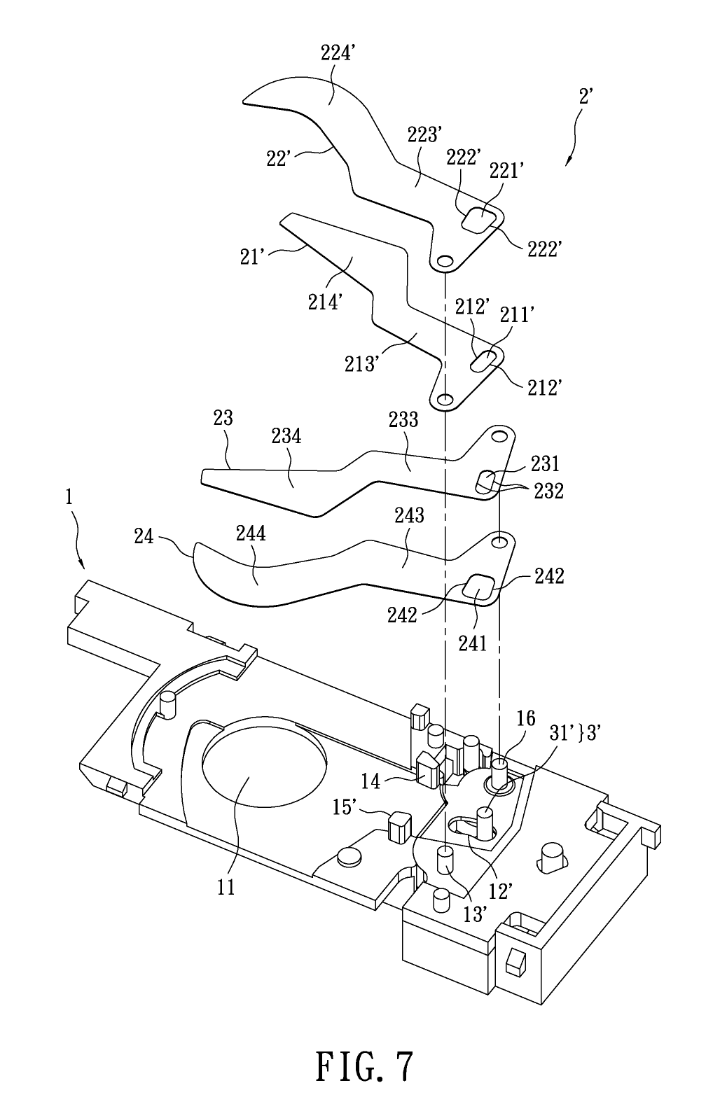

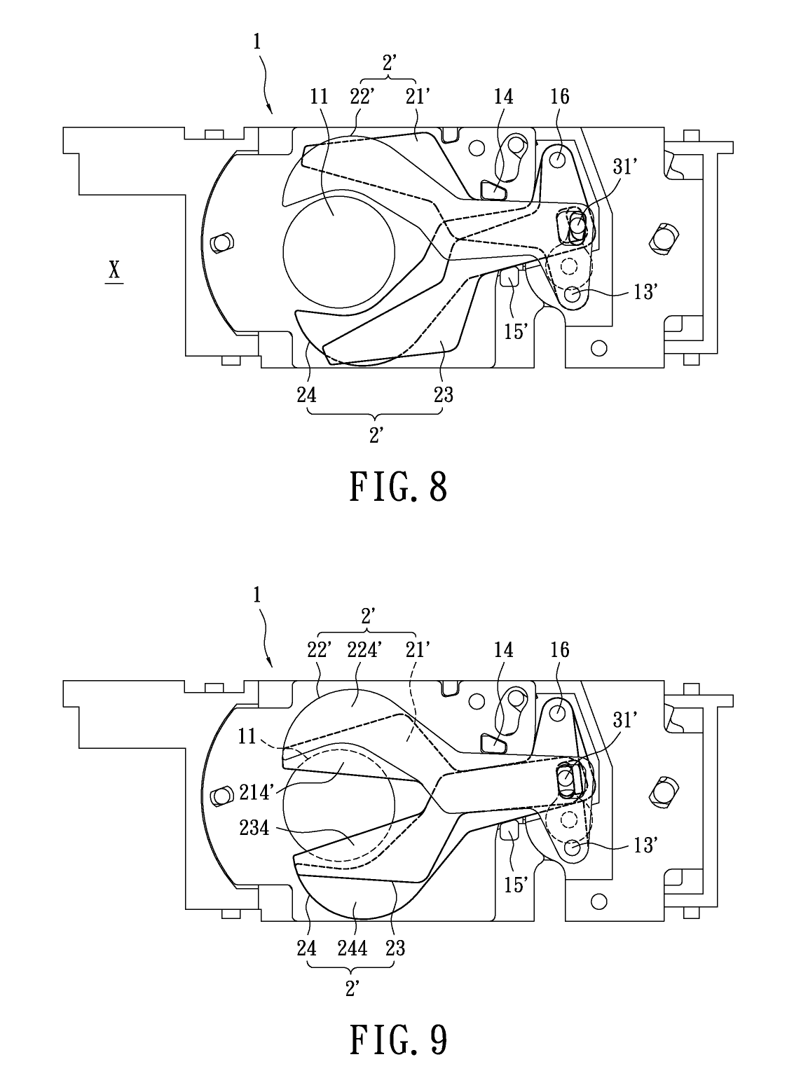

Please refer to FIGS. 7˜11, which show a second embodiment of the instant disclosure. FIG. 7 is an exploded view of the instant embodiment, while FIGS. 8˜11 illustrate the blade assembly at various states.

As shown in FIG. 7, an image recording device comprises the base plate 1, a blade assembly 2′, and a driving mechanism 3′. The blade assembly 2′ and the driving mechanism 3′ are both arranged on the base plate 1. The blade assembly 2′ is driven by the driving mechanism 3′. For the instant embodiment, the blade assembly 2′ is a set of shutter blades, but is not restricted thereto.

The aperture 11 and a guiding slot 12′ are formed on the base plate 1. A second axle 16′ is formed protrudingly on the base plate 1, in addition to a first axle 13′, the first retaining block 14, and a second retaining block 15′. All aforementioned elements protrude in the same direction.

The blade assembly 2′ includes a first blade 21′, a second blade 22′, a third blade 23, and a fourth blade 24. The first and second blades 21′ and 22′ are hinged to the first axle 13′ and arranged in an overlapping manner on the base plate 1, while the third and fourth blades 23 and 24 are hinged to the second axle 16 and stacked on the base plate 1.

The first blade 21′ has an arm portion 213′, which is extended in forming a covering portion 214′. The arm portion 213′ further has a first pivot slot 211′ formed thereon. The first pivot slot 211′ has two first inner walls 212′ formed apart oppositely. The arm portion 213′ is hinged to the first axle 13′.

The second blade 22′ also has an arm portion 223′, which is extended likewise in forming a covering portion 224′. The arm portion 223′ further has a second pivot slot 221′ formed thereon. The second pivot slot 221′ has two second inner walls 222′ formed apart oppositely. Notably, the distance between the two second inner walls 222′ is greater than the distance between the two first inner walls 212′. The arm portion 223′ is also hinged to the first axle 13′.

The third blade 23 has an arm portion 233, which is extended in forming a covering portion 234. The arm portion 233 further has a third pivot slot 231 formed thereon. The third pivot slot 231 has a third inner gauge defined by two opposing inner walls 232. The arm portion 233 is hinged to the second axle 16.

The fourth blade 24 also has an arm portion 243, which is extended likewise in forming a covering portion 244. The arm portion 243 further has a fourth pivot slot 241 formed thereon. The fourth pivot slot 241 has a fourth inner gauge defined by two opposing inner walls 242. Notably, the distance between the two fourth inner walls 242 is greater than the distance between the two third inner walls 232. The arm portion 243 is also hinged to the second axle 16.

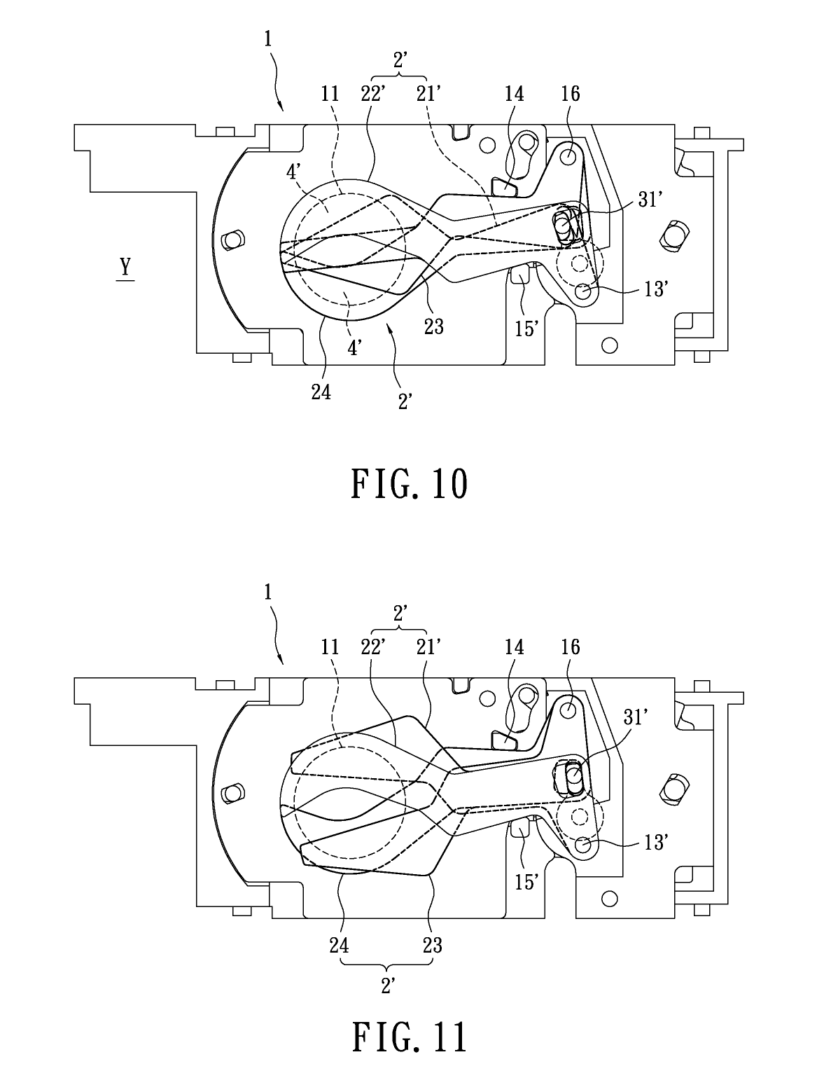

The driving mechanism 3′ includes a pin member 31′, which is movably projected through the guiding slot 12′, the first pivot slot 211′, the second pivot slot 221′, the third pivot slot 231, and the fourth pivot slot 241. By moving against the first inner walls 212′, the second inner walls 222′, the third inner walls 232, and the fourth inner walls 242, the pin member 31′ can switch the blade assembly 2 between the open position X and the closed position Y over the aperture 11 (as shown in FIGS. 8 and 10).

Different operation states of the image recording device are illustrated in FIGS. 8˜11. The blade assembly 2 shown in the figures is a set of shutter blades. Detailed descriptions of each operation state are given herein.

Please refer to FIG. 8 in conjunction with FIG. 7. In FIG. 8, the blade assembly 2 is oriented at the open position X. Specifically, the first blade 21′ and the second blade 22′ are held away from the aperture 11. The corresponding arm portions 213′ and 223′ are abutted to the first retaining block 14. Meanwhile, the third blade 23 and the fourth blade 24 are held at another side of the aperture 11. The corresponding arm portions 233 and 243 are abutted to the second retaining block 15′. The pin member 31′ is being hugged by the first inner walls 212′ and the third inner walls 232, while abutting to one of the second inner wall 222′ and one of the fourth inner wall 242.

Notably, the first blade 21′ and the second blade 22′ are arranged in a stacker manner. Same type of arrangement is also applied to the third and fourth blades 23 and 24. The stacked (overlapping) configuration reduces the required occupying area of the blades on the base plate 1, which allows the image recoding device to be downsized.

Please refer to FIG. 9 in conjunction with FIG. 7. FIG. 9 shows the transitioning of the blade assembly 2 from the open position X toward the closed position Y. As pointed out previously, the distance between the two second inner walls 222′ is greater than the distance between the two first inner walls 212′, while the distance between the two fourth inner walls 242 is greater than the distance between the two third inner walls 232. When the pin member 31′ starts to move, the first blade 21′ and the third blade 23 are set in motion first accordingly, while the pin member 31′ moves toward the opposite second inner wall 222′ and the opposite fourth inner wall 242. By pushing the opposite second inner wall 222′ and the fourth inner wall 242, the pin member 31′ forces the second blade 22′ and the fourth blade 24 to rotate as well, before stopping at the closed position Y.

As illustrated, the first and second blades 21′ and 22′ are hinged to the first axle 13′, and the third and fourth blades 23 and 24 are hinged to the second axle 16. The rotation of the second and fourth blades 22′ and 24 are designed to lag behind the first and third blades 21′ and 23, respectively. In other words, the turning angle of the second and fourth blades 22′ and 24 are comparatively smaller than the first and third blades 21′ and 23. Thereby, when all the blades are rotated, the corresponding covering portions can form the desired pattern over the aperture 11.

Please refer to FIG. 10 in conjunction with FIG. 7. In FIG. 10, the blade assembly 2′ is oriented at the closed position Y over the aperture 11. The arm portions 213′ and 223′ of the first and second blade 21′ and 22′ are abutted to the second retaining block 15′, while the arm portions 233 and 243 of the third and fourth blade 23 and 24 are abutted to the first retaining block 14. Especially, a small opening 4′ is formed between the covering portion 214′ of the first blade 21, the covering portion 234 of the third blade 23, and the aperture 11, while the covering portion 224′ of the second blade 22 and the covering portion 244 of the fourth blade 24 covers the opening 4′.

Please refer to FIG. 11 in conjunction with FIG. 7. FIG. 11 shows the returning of the blade assembly 2 from the closed position Y to the open position X. Like before, the pin member 31′ first forces the first blade 21′ and the third blade 23 to rotate, and after a pre-determined delay, the second blade 22′ and the fourth blade 24 are forced to follow the first blade 21′ and the third blade 23 respectively, before stopping at the open position X.

For explaining purposes, the blade assembly 2′ of the instant embodiment includes four blades. However, when in use, the number of the blades is not restricted.

### Advantages

Regardless of the blade assembly 2, 2′ being a set of aperture blades or shutter blades, the stacked configuration of the blade assembly 2, 2′ allows the image recording device to be miniaturized.

In addition, the lagging operation between the overlapping blades of the blade assembly 2, 2′ allows the formation of different blade patterns to cover the aperture.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. An image recording device, comprising:
a base plate having an aperture, a guiding slot, and a first axle formed thereon;
a blade assembly having a first blade and a second blade rotatably disposed on the first axle overlapping each other, the first blade including a first pivot slot formed thereon having a first inner gauge, the second blade including a second pivot slot having a second inner gauge,
wherein the second inner gauge is greater than the first inner gauge,
wherein the wider separation between the second inner walls makes the second blade to rotate laggingly behind the first blade in forming specified blade pattern over the aperture; and
a driving mechanism having a pin member, the pin member being projected through the guiding slot, the first pivot slot, and the second pivot slot to drive the blade assembly.

2. The image recording device of claim 1, wherein the blade assembly can be arranged at an open position or at a closed position, and wherein for the closed position, the first blade is disposed over the aperture and an opening is formed therebetween, while the second blade is also disposed over the aperture to cover the opening.

3. The image recording device of claim 2, wherein all the blades are arranged away from the aperture at the open position to uncover the aperture completely.

4. The image recording device of claim 3, wherein each blade has an arm portion and a covering portion extended therefrom, and wherein each covering portion is disposed over the aperture when the blade assembly is at closed position.

5. The image recording device of claim 1, wherein the blade assembly is a set of aperture blades.

6. The image recording device of claim 1, wherein the base plate further has a second axle formed thereon, the blade assembly having an additional third blade and a fourth blade stacked on the base plate for space saving, the third blade and the fourth blade being hinged to the second axle, the third blade having a third pivot slot formed thereon, the third pivot slot having two third inner walls formed oppositely, the fourth blade having a fourth pivot slot formed thereon, the fourth pivot slot having two fourth inner walls formed oppositely, the distance between the two fourth inner walls being greater than the distance between the two third inner walls, wherein the wider separation between the fourth inner walls makes the fourth blade to rotate laggingly behind the third blade in forming specified blade pattern over the aperture, and wherein the third blade and the fourth blade is driven rotatably by the pin member.

7. The image recording device of claim 6, wherein the blade assembly can be arranged at an open position or at a closed position, and wherein for the closed position, the first blade and the third blade are disposed over the aperture and an opening is formed therebetween, while the second blade and the fourth blade are also disposed over the aperture to cover the opening.

8. The image recording device of claim 7, wherein for the open position, all blades of the blade assembly are arranged away from the aperture to uncover the aperture completely.

9. The image recording device of claim 8, wherein each blade has an arm portion and a covering portion extended therefrom, and wherein each covering portion is disposed over the aperture when the blade assembly is at the closed position.

10. The image recording device of claim 6, wherein the blade assembly is a set of shutter blades.
